(19) United States
(12) Patent Application Publication
(10) Pub. No.: US 2012/0110549 A1
(43) Pub. Date: May 3, 2012

(54) Code Breakage Detection Using Source Code History Background

(75) Inventors: Steven John Earl Gutz, Gloucester (CA); Thomas Anthony MacDougall, Kanata (CA); Mohammed Mostafa, Kanata (CA)

(73) Assignee: INTERNATIONAL BUSINESS MACHINES CORPORATION, Armonk, NY (US)

(21) Appl. No.: 13/154,210

(22) Filed: Jun. 6, 2011

(30) Foreign Application Priority Data
Oct. 29, 2010 (CA) 2719782

(51) Int. Cl. G06F 9/44

(52) U.S. Cl. 717/120; 717/127

(57) ABSTRACT

An illustrative embodiment of a computer-implemented process for detecting code breakage using source code change history receives a point in time within an identified range of time to form a selected time, receives a set of source files associated with the a selected time, receives a set of history files associated with the received set of source files and initializes a workspace in a sandbox using the set of source files and the set of history files. The computer-implemented process incrementally executes the received set of source files from the selected time forward, determines whether a code break occurs and responsive to a determination that the code break occurs, presents a list of files. The computer-implemented process receives an identified file from the list of files to form a suspect file, and receives a correction for the suspect file.

### BACKGROUND

1. Technical Field

This disclosure relates generally to software applications executable by a device and more specifically to developing the software applications executable by the device.

2. Description of the Related Art

When developing software, a developer will often change multiple files in a short period of time. Problems can be introduced at any time during the changes. Testing of functionality that worked earlier (with a previous line up of files) may not be attempted after each change and it becomes increasingly difficult to pinpoint a change that caused a regression as time goes on.

With regard to FIG. 3 a time series diagram of a file change history in accordance with various embodiments of the disclosure is presented. File change history 300 is an example of a file change sequence over time 302. A time between a time of 10:00 304 and a time of 10:38 306 comprises a number of file changes such as change 314 and change 316.

Time line of time 302 shows that the code worked sometime before a time of 10:50 but was broken after a time of 10:38, as code broken here 310. In between many files changed (possibly by many other developers on the team), and while individual unit tests for each class may have passed, the integration between them may be failing in subtle ways. A time period 312 between a time of 10:00 304 and a time of 10:38 306 indicates region of instability 312 for the changed code. Region of instability 312 is also defined by a marker of code worked here 308 and code broken here 310.

Since software engineers are typically poor testers, a cause of the breakage may go undetected for a period of time. The example shows a small time change, as time period 312 between a time of 10:00 304 and a time of 10:38 306, but often code breakages are not detected for hours or even days after a change. As a result the developer is forced to start a manual process to rewind changes performed on the source code to get to a root cause of the breakage. In complex systems with multiple developers the manual process can be a costly and painful exercise.

To alleviate the problem, code management systems have introduced concepts such as activities enabling a developer to group source code changes into a single group. Activity-based development tends to be course grained and effectively isolates work of one developer from other members of a team. The isolation often contributes to problems of code breakage during code integration from each developer into a main code stream. Further, activities for a single developer are often intertwined across several tasks; accordingly unexpected code breakages are frequently harder to resolve in an activity focused development process.

### BRIEF SUMMARY

According to one embodiment, a computer-implemented process for detecting code breakage using source code change history receives a point in time within an identified range of time to form a selected time, receives a set of source files associated with the a selected time, receives a set of history files associated with the received set of source files and initializes a workspace in a sandbox using the set of source files and the set of history files. The computer-implemented process incrementally executes the received set of source files from the selected time forward, determines whether a code break occurs and responsive to a determination that the code break occurs, presents a list of files. The computer-implemented process receives an identified file from the list of files to form a suspect file, opens a file compare tool for the suspect file and receives a correction for the suspect file.

According to another embodiment, a computer program product for detecting code breakage using source code change history comprises a computer recordable-type media containing computer executable program code stored thereon. The computer executable program code comprises computer executable program code for receiving a point in time within an identified range of time to form a selected time, computer executable program code for receiving a set of source files associated with the selected time, computer executable program code for receiving a set of history files associated with the received set of source files and computer executable program code for initializing a workspace in a sandbox using the set of source files and the set of history files. The computer program product further comprises computer executable program code for incrementally executing the received set of source files from the selected time forward, computer executable program code for determining whether a code break occurs, and computer executable program code responsive to a determination that the code break occurs, for presenting a list of files. The computer program product further comprises computer executable program code for receiving an identified file from the list of files to form a suspect file, computer executable program code for opening a file compare tool for the suspect file and computer executable program code for receiving a correction for the suspect file.

According to another embodiment, an apparatus for detecting code breakage using source code change history comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to receive a point in time within an identified range of time to form a selected time, receive a set of source files associated with the a selected time, receive a set of history files associated with the received set of source files and initialize a workspace in a sandbox using the set of source files and the set of history files. The processor unit executes the computer executable program code to further direct the apparatus to incrementally execute the received set of source files from the selected time forward, determine whether a code break occurs and responsive to a determination that the code break occurs, present a list of files. The processor unit executes the computer executable program code to further direct the apparatus to receive an identified file from the list of files to form a suspect file, open a file compare tool for the suspect file and receive a correction for the suspect file.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system network operable for various embodiments of the disclosure;

FIG. 2 is a block diagram of an exemplary data processing system operable for various embodiments of the disclosure;

FIG. 3 is a time series diagram of a file change history in accordance with various embodiments of the disclosure;

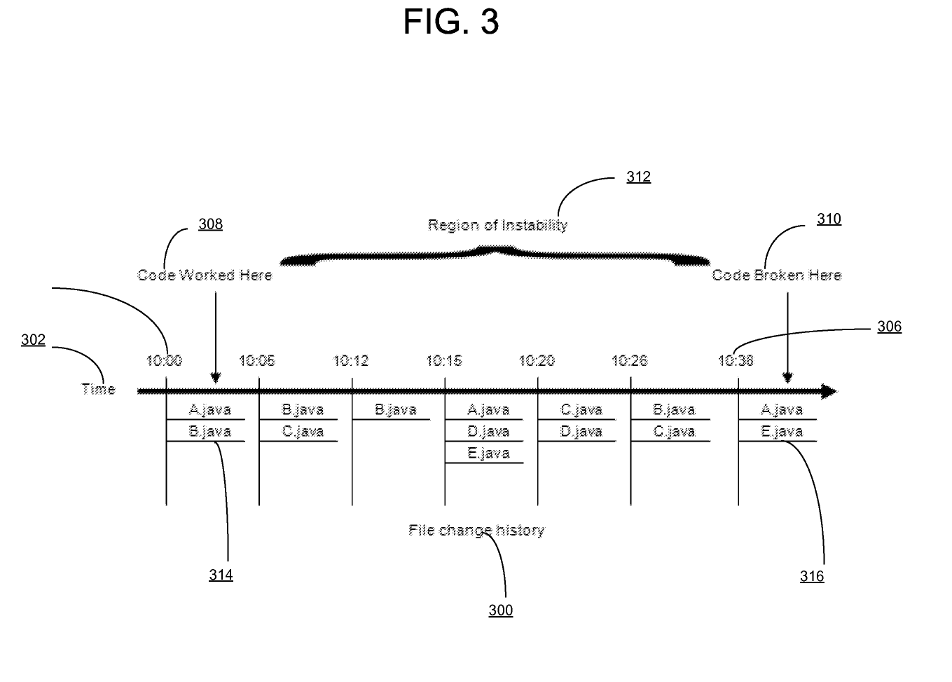

FIG. 4 is a block diagram of components of a system for detecting code breakage using source code change history, in accordance with various embodiments of the disclosure;

FIG. 5 is a pictorial diagram of a user interface portion for the system for detecting code breakage using source code change history of FIG. 4, in accordance with one embodiment of the disclosure; and

FIG. 6 is a flowchart of a process for detecting code breakage using source code change history using the user interface portion of FIG. 5, in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc. or any suitable combination of the foregoing.

Computer program code for carrying out operations for aspects of the present disclosure may be written in any combination of one or more programming languages, including an object oriented programming language such as Java™, Smalltalk, C++, or the like and conventional procedural programming languages, such as the “C” programming language or similar programming languages. Java and all Java-based trademarks and logos are trademarks of Sun Microsystems, Inc., in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus, (systems), and computer program products according to various embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented method such that the instructions which execute on the computer or other programmable apparatus provide methods for implementing the functions/acts specified in the flowchart and/or block diagram block or blocks.

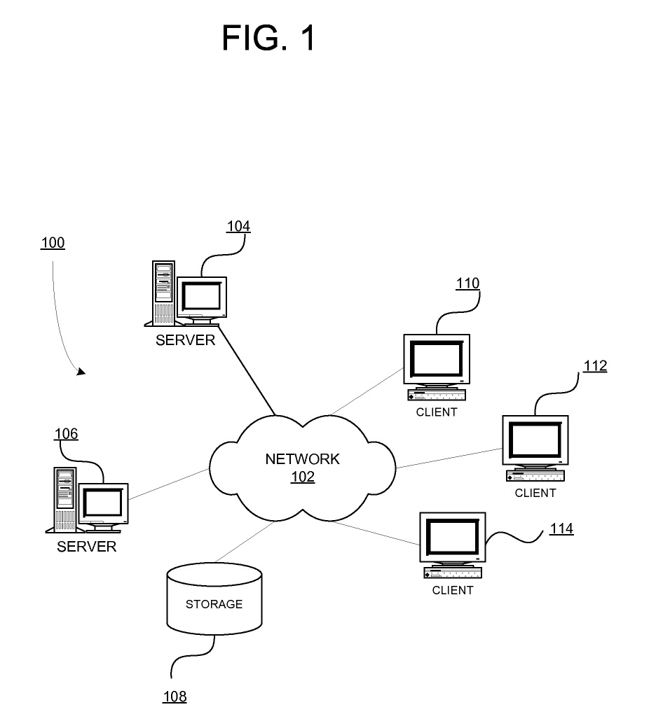

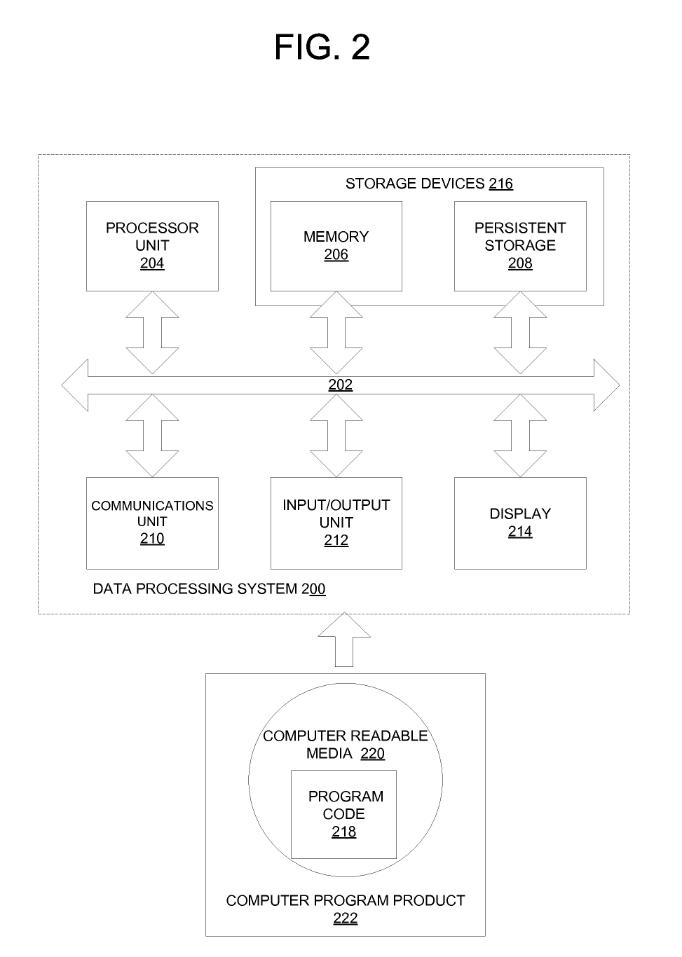

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The methods of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented method for detecting code breakage using source code change history receives a point in time within an identified range of time to form a selected time, receives a set of source files associated with the a selected time, receives a set of history files associated with the received set of source files and initializes a workspace in a sandbox using the set of source files and the set of history files. The computer-implemented method incrementally executes the received set of source files from the selected time forward, determines whether a code break occurs and responsive to a determination that the code break occurs, presents a list of files. The computer-implemented method receives an identified file from the list of files to form a suspect file, opens a file compare tool for the suspect file and receives a correction for the suspect file.

Processor unit 204 receives a point in time within an identified range of time, typically from display 214 to form a selected time, receives a set of source files associated with the a selected time, receives a set of history files associated with the received set of source files from communications unit 210 or from storage devices 216. Processor unit 204 initializes a workspace in a sandbox using the set of source files and the set of history files. Processor unit 204 incrementally executes the received set of source files from the selected time forward, determines whether a code break occurs and responsive to a determination that the code break occurs, presents a list of files using display 214. Processor unit 204 receives an identified file from the list of files to form a suspect file, opens a file compare tool for the suspect file and receives a correction for the suspect file.

In another example, a computer-implemented method, using program code 218 stored in memory 206 or as a computer program product 222, for detecting code breakage using source code change history comprises a computer recordable storage media, such as computer readable media 220, containing computer executable program code stored thereon. The computer executable program code comprises computer executable program code for detecting code breakage using source code change history.

In another illustrative embodiment, the method for detecting code breakage using source code change history may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the method for detecting code breakage using source code change history.

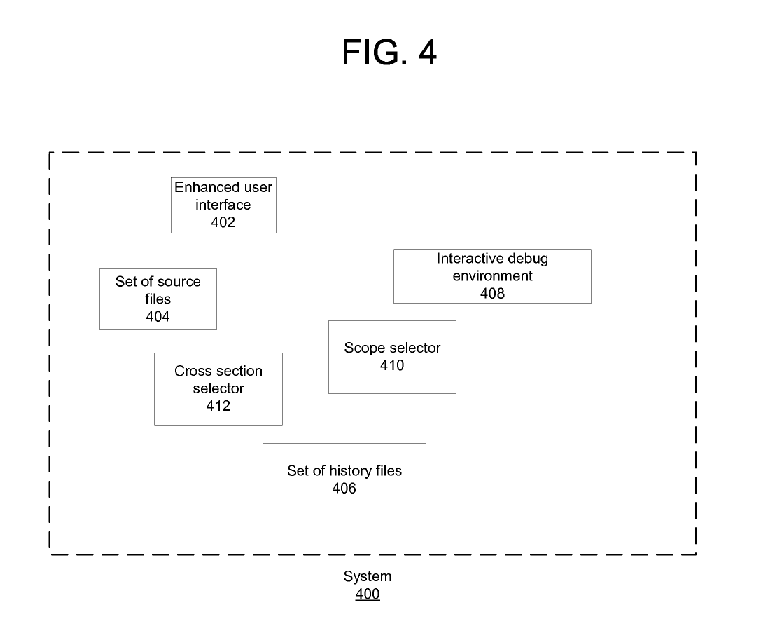

With reference to FIG. 4, a block diagram of a system, in accordance with various embodiments of the disclosure is presented. System 400 is an example of a system for detecting code breakage using source code change history implemented using a foundation of data processing system 200 of FIG. 2.

Embodiments of system 400 enable a user to easily reconstruct a set of files at any time in recorded local history. Many modern integrated development environments (IDE), for example, Eclipse™¹, maintain saved versions of a file, also known as local history. Embodiments of system 400 leverage the historical file information and enable a developer to revert to a point before code breakage and then incrementally execute code changes forward until the break is detected. In addition, the IDE typically maintains flags on a file (where applicable) indicating a state of the file, for example, errors, and warnings, enabling a user to jump to points where the code base was in a usable or known good state. Software developers typically perform automatic testing, for example JUnits, (a tool for project testing and debugging using a theory of test-driven development) at known good points and determine a first point where the code manifested a problem. ¹Eclipse is a trademark of Eclipse Foundation, Inc.

System 400 comprises a number of components including enhanced user interface 402, set of source files 404, set of history files 406, interactive debug environment 408, scope selector 410 and a cross section selector 412.

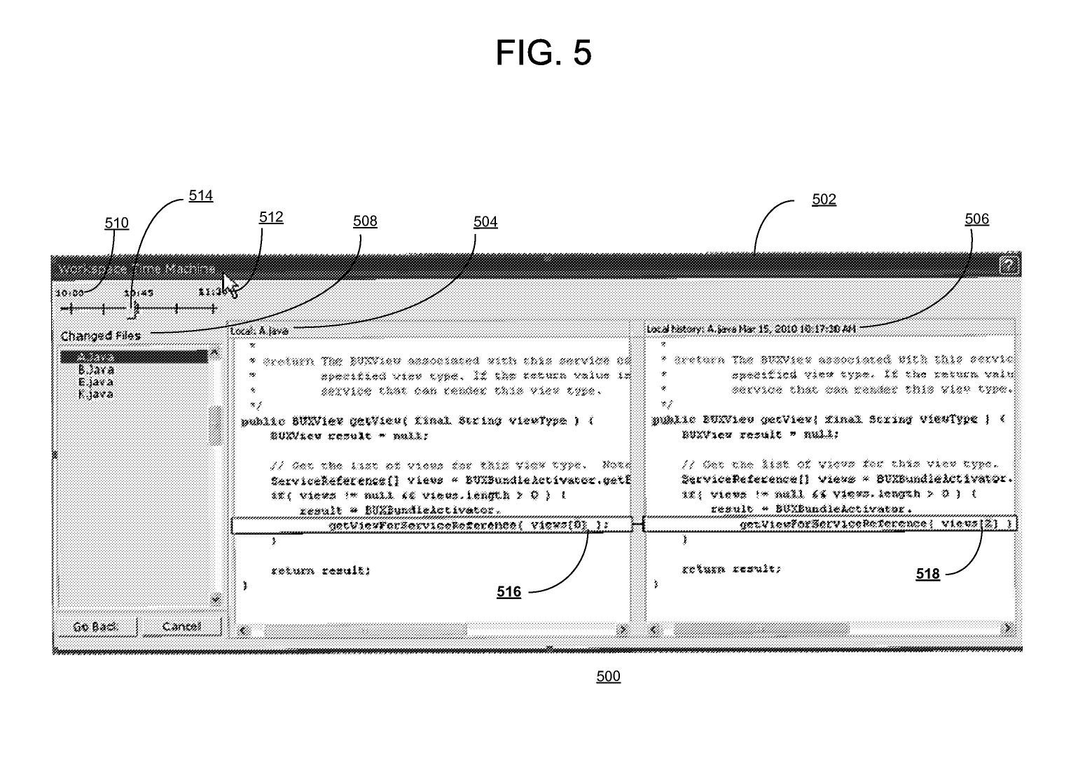

Enhanced user interface 402 provides a user dialog capability for the operations of the disclosed method for detecting code breakage using source code change history. Enhanced user interface 402 provides a visualization of controls for selecting appropriate timeframe and data used with the method. For example, enhanced user interface 402 provides a viewing region within which source file and a corresponding history file version of the same source file may be seen concurrently. Enhanced user interface 402 also provides a list files for a selectable corresponding point in time of interest. An example of enhanced user interface 402 is further described in FIG. 5.

Set of source files 404 comprises one or more source code units which are to be processed corresponding to a selected software component of interest. For example, when a code breakage is known or suspected a defined number of source code units are identified as suspect and examined to determine a root cause of a problem. Set of source files 404 is managed within interactive debug environment 408 without a need of check-in and checkout of a source code management system.

Set of history files 406 is one or more source code units associated with set of source files 404. Set of history files 406 represents a file change history for each file in set of source files 404 that has been added, deleted or changed within a selectable time frame. Set of history files 406 is managed within interactive debug environment 408 without a need of check-in and checkout of a source code management system.

Interactive debug environment 408 provides a capability to add, change and delete source code units and to track such changes in corresponding files. Interactive debug environment 408 also provides a capability to define and change a re-defined workspace or development environment in accordance with a selection of files, such as set of source files 404. For example, a workspace of interactive debug environment 408 may be set selectively to a specific point within a timeline of development for which set of history files 406 exists using a subset of set of source files 404 as specified by a user. Having set a workspace interactive debug environment 408 further provides a capability to create a run time environment and incrementally execute code changes forward until a break is detected.

Scope selector 410 provides a capability to determine a range, or scope, of code under review. Scope may be defined in terms of selectable units comprising a full IDE, a set of projects, a cross cutting set of files, a time frame, a specific number of changes, number of errors or warnings and a number of files. Cross section selector 412 provides a capability to define individual slices of code identified within scope, whether or not the code can be compiled. A cross cutting set of files may be similar to a working set in Eclipse.

With reference to FIG. 5, a pictorial diagram of a user interface portion, in accordance with various embodiments of the disclosure is presented. User interface portion 500 is an example of a user interface dialog used in a method for detecting code breakage using source code change history of system 400 of FIG. 4.

In the example provided, user interface portion 500 accesses local history information maintained by an interactive development environment and provides an interface enabling a developer to move back in a development timeline to a point where code of interest worked correctly. User interface 500 presents a display window 502 with a representation of a file that is current 504 and historical 506 arranged for simultaneous viewing and comparison. Historical 506 also displays time and date information associated with a last update of the respective file. The illustrative embodiment provides a time machine feature providing a capability of detecting code breakage using source code change history.

A user is able to move back in a development timeline to a point where code of interest worked correctly using slider control 514 to select an historically significant time in the development cycle between start time 510 and end time 512. The user may further select an option to make a current workspace function as of the selected previous moment in time. Some interactive development environments (IDE) currently enable a user to run with a proposed line up, therefore time stamped files could be placed in a test sandbox without forcing changes to a current workspace.

The user is shown list of the files 508 that have been added, changed or removed between a present time and a time selected. In the current example, value 516 in current 504 differs from a similar value 518 in historical 506, which may be a significant difference. In the event the user cannot recall a specific file change a file compare tool is used to open a respective file to view changes made.

When a known code snapshot has been verified a user moves the time forward incrementally using slider control 514. Slider control 514 enables the user to control a time slice to pinpoint an exact time when a code breakage occurred.

In another illustrative embodiment, rather than listing individual files, a concept of scope could be used enabling a user to view and specify sets of files for consideration. Examples of scope include settings comprising a full IDE workspace, a set of projects or a cross section forming a set of files similar to a working set in Eclipse.

In another illustrative embodiment, linking the time machine feature to an existing code management system thereby making the activity more fine-grained enhances activity-based development. Using this example, a user initially limits code breakage to a single course-grained activity and then uses time reversal capabilities of the embodiment to provide a capability for fine-grained resolution to link breakage to a specific file within an activity. Activities are viewed as overlays of changed files. User interface portion 500 is augmented to group changed files into “activity clusters”.

In addition, code points, which can be compiled for a specific scope, are identified. Also, when a user identifies a specific time slice which is able to be compiled for testing, an applicable set of files is added to a sandbox of the user and a runtime is created using the files of the respective set. Other tools typically do not allow a user to choose individual cross sections of scoped code (whether or not code can be compiled). Illustrative embodiments provide the described capability with files in a local history, for example in Eclipse, without being checked into a source code management offering.

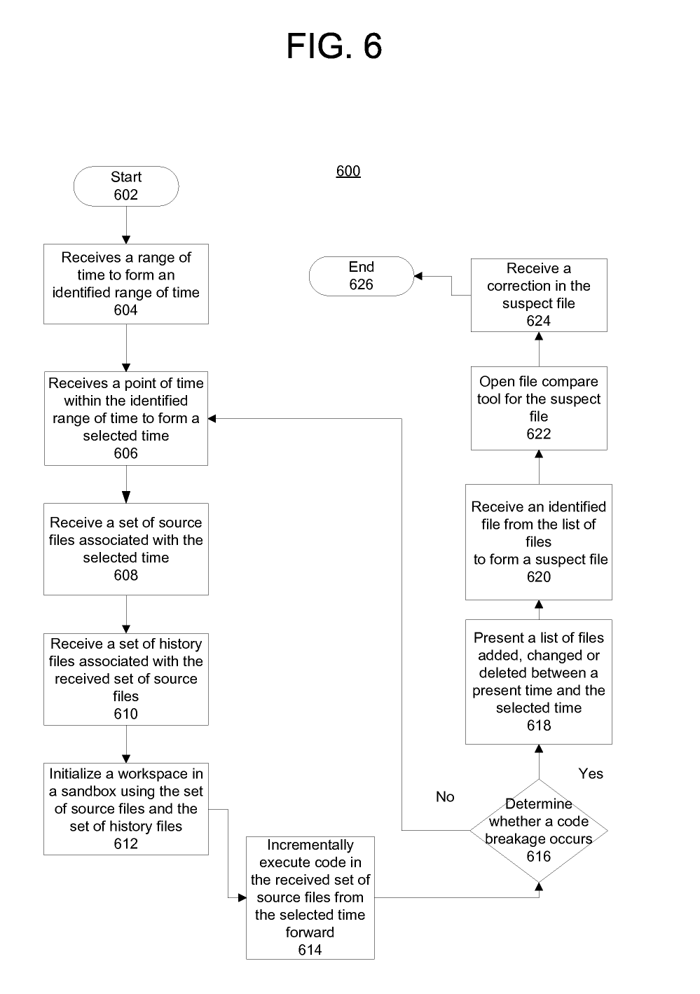

With reference to FIG. 6, a flowchart of a method for detecting code breakage using source code change history, in accordance with one embodiment of the disclosure is presented. Method 600 is an example of a method for detecting code breakage using source code change history using system 400 of FIG. 4.

Method 600 begins (act 602) and receives a range of time to form an identified range of time (act 604). Method 600 receives a point of time within the identified range of time to form a selected time (act 606). The selected time is typically a time at which the code base being processed is known to be good. The selected time therefore forms a starting point for determining existence of a code breakage.

Method 600 receives a set of source files associated with the selected time (act 608). Method 600 receives a set of history files associated with the received set of source files (act 610). A file in the set of history files may have a set of one or more flags present, typically set by a debug environment process. The flags may be used to indicate additional information such as state information including errors, warnings, condition codes that may have resulted from prior processing. Prior processing could include adding, deleting, editing of a file, and unit testing.

Alternatively a scope may be set in which a collection of activities in a cluster or an activity (over a number of associated files) is established to determine which source files and history files are to be used in method 600. Scope setting therefore becomes a quick method of collecting resources to aid in determining code breakage.

Method 600 initializes a workspace in a sandbox using the received set of sources files and set of history files (act 612). Use of a sandbox technique avoids having a current environment changed in the performance of a code debugging exercise. The current environment is thus preserved while further changes are prevented from being introduced and thereby at worst possibly increasing a likelihood of a bad change and at best increasing the difficulty of finding a root cause.

Method 600 incrementally executes code in the received set of source files from the selected time forward (act 614). Method 600 determines whether a code breakage occurs (act 616). Responsive to a determination that a code breakage does not occur, method 600 loops back to perform act 606 as before.

Responsive to a determination that a code breakage occurs, method 600 presents a list of files added, changed or deleted between a present time and the selected time (act 618). Method 600 receives an identified file from the list of files to form a suspect file (act 620). Method 600 opens a file compare tool for the suspect file (act 622). Method 600 receives a correction in the suspect file (act 624) and terminates thereafter (act 626). A code change has been validated and work may proceed with other files or at other times as needed. Code analysis is not performed. Code investigation and comparison is performed prior to execution and testing typically performed. Compilation points placed within the code base for the identified range of time enables automated testing to be performed at the identified times to narrow the window in which a code breakage occurs.

Thus is presented in one embodiment a computer-implemented method for detecting code breakage using source code change history receives a point in time within an identified range of time to form a selected time, receives a set of source files associated with the a selected time, receives a set of history files associated with the received set of source files and initializes a workspace in a sandbox using the set of source files and the set of history files. The computer-implemented method incrementally executes the received set of source files from the selected time forward, determines whether a code break occurs and responsive to a determination that the code break occurs, presents a list of files. The computer-implemented method receives an identified file from the list of files to form a suspect file, opens a file compare tool for the suspect file and receives a correction for the suspect file.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the techniques of the disclosure have been presented for purposes of illustration and description, but is not intended to be exhaustive or limited to the techniques in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Embodiments of the disclosure can take the form of an entirely hardware embodiment, an entirely software embodiment or an embodiment containing both hardware and software elements. In a preferred embodiment, the techniques of the disclosure are implemented in software, which includes but is not limited to firmware, resident software, microcode, and other software media that may be recognized by one skilled in the art.

It is important to note that while techniques of the present disclosure has been described in the context of a fully functioning data processing system, those of ordinary skill in the art will appreciate that the methods of the present disclosure are capable of being distributed in the form of a computer readable medium of instructions and a variety of forms and that the present disclosure applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the techniques of the present disclosure has been presented for purposes of illustration and description, and is not intended to be exhaustive or limited to the techniques in the form disclosed. Many modifications and variations will be apparent to those of ordinary skill in the art. The embodiment was chosen and described in order to best explain the principles of the disclosure, the practical application, and to enable others of ordinary skill in the art to understand the techniques of the disclosure for various embodiments with various modifications as are suited to the particular use contemplated.

What is claimed is:

1. A computer-implemented method for detecting code breakage using source code change history, the computer-implemented method comprising:
receiving a point in time within an identified range of time to form a selected time;
receiving a set of source files associated with the selected time;
receiving a set of history files associated with the received set of source files;
initializing a workspace using the set of source files and the set of history files;
incrementally executing the received set of source files from the selected time forward;
determining whether a code break occurs;
responsive to a determination that the code break occurs, presenting a list of files;
receiving an identified file from the list of files to form a suspect file; and
receiving a correction for the suspect file.

2. The computer-implemented method of claim 1 wherein receiving the point in time within the identified range of time to form a selected time further comprises:
receiving a range of time to form an identified range of time; and
receiving a point in time through a graphical slider control to select a time in the development cycle.

3. The computer-implemented method of claim 1 wherein receiving the set of source files associated with the selected time further comprises:
setting a scope, wherein the scope comprises one of a collection of activities in a cluster or an activity over a number of associated files is established to determine which source files and history files are used.

4. The computer-implemented method of claim 1 wherein the set of source files associated with the selected time and the set of history files associated with the received set of source files are managed within an interactive debug environment.

5. The computer-implemented method of claim 1 wherein initializing the workspace using the set of source files and the set of history files further comprises:
preserving a current environment, wherein preserving prevents change to the current environment by use of the set of source files and the set of history files.

6. The computer-implemented method of claim 1 further comprising:
placing compilation points within a code base for the identified range of time, wherein the compilation points enable automated testing at the selected times to narrow a window in which a code breakage occurs.

7. The computer-implemented method of claim 1 wherein a file in the set of source files and the set of history files have a set of one or more flags present, wherein the set of one or more flags is set by a debug environment process and wherein the flags indicate state information including errors, warnings, and condition codes.

8. The computer-implemented method of claim 1, further comprising:
opening a file compare tool for the suspect file; and
displaying changes made to the suspect file within the identified range of time with the file compare tool.

9. A computer program product for detecting code breakage using source code change history, the computer program product comprising:
a computer storage media having computer readable program code embodied therewith, the computer readable program code comprising:
computer readable program code configured to receive a point in time within an identified range of time to form a selected time;
computer readable program code configured to receive a set of source files associated with the selected time;
computer readable program code configured to receive a set of history files associated with the received set of source files;
computer readable program code configured to initialize a workspace using the set of source files and the set of history files;
computer readable program code configured to incrementally execute the received set of source files from the selected time forward;
computer readable program code configured to determine whether a code break occurs;
computer readable program code configured to present a list of files responsive to a determination that the code break occurs;
computer readable program code configured to receive an identified file from the list of files to form a suspect file; and
computer readable program code configured to receive a correction for the suspect file.

10. The computer program product of claim 9, wherein computer readable program code configured to receive a point in time within an identified range of time to form a selected time further comprises:
computer readable program code configured to receive a range of time to form an identified range of time; and
computer readable program code configured to receive a point in time through a graphical slider control to select a time in the development cycle.

11. The computer program product of claim 9, wherein computer readable program code configured to receive the set of source files associated with the selected time further comprises:
computer executable program code configured to set a scope, wherein the scope comprises one of a collection of activities in a cluster or an activity over a number of associated files is established to determine which source files and history files are used.

12. The computer program product of claim 9, wherein the set of source files associated with the selected time and the set of history files associated with the received set of source files are managed within an interactive debug environment.

13. The computer program product of claim 9, wherein computer readable program code configured to initialize the workspace using the set of source files and the set of history files further comprises:
computer readable program code configured to preserve a current environment, wherein computer readable program code configured to preserve prevents change to the current environment by use of the set of source files and the set of history files.

14. The computer program product of claim 9, further comprising:
computer readable program code configured to place compilation points within a code base for the identified range of time, wherein the compilation points enable automated testing at the selected times to narrow a window in which a code breakage occurs.

15. The computer program product of claim 9, wherein the file in the set of source files and the set of history files have a set of one or more flags present, wherein the set of one or more flags is set by a debug environment process and wherein the flags indicate state information including errors, warnings, and condition codes.

16. The computer program product of claim 9, further comprising:
computer readable program code configured to open a file compare tool for the suspect file; and
computer readable program code configured to display changes made to the suspect file within the identified range of time in the file compare tool.

17. An apparatus for detecting code breakage using source code change history, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
receive a point in time within an identified range of time to form a selected time;
receive a set of source files associated with the a selected time;
receive a set of history files associated with the received set of source files;
initialize a workspace in a sandbox using the set of source files and the set of history files;
incrementally execute the received set of source files from the selected time forward;
determine whether a code break occurs;
responsive to a determination that the code break occurs, present a list of files;
receive an identified file from the list of files to form a suspect file; and
receive a correction for the suspect file.

18. The apparatus of claim 17, wherein the processor unit executes the computer executable program code to receive the point in time within an identified range of time to form the selected time further directs the apparatus to:
receive a range of time to form an identified range of time; and
receive a point in time through a graphical slider control to select a time in the development cycle.

19. The apparatus of claim 17, wherein the processor unit executes the computer executable program code to receive the set of source files associated with the selected time further directs the apparatus to:
set a scope, wherein the scope comprises one of a collection of activities in a cluster or an activity over a number of associated files is established to determine which source files and history files are used.

20. The apparatus of claim 17, wherein the set of source files associated with the selected time and the set of history files associated with the received set of source files are managed within an interactive debug environment.
